(19) United States
(12) Patent Application Publication
(10) Pub. No.: US 2025/0045246 A1
(43) Pub. Date: Feb. 6, 2025

(54) METHOD AND APPARATUS, ELECTRONIC DEVICE, AND STORAGE MEDIUM FOR PROCESSING INFORMATION

(71) Applicant: Beijing Zitiao Network Technology Co., Ltd., Beijing (CN)

(72) Inventors: Yang GUO, Beijing (CN); Eran YU, Beijing (CN)

(21) Appl. No.: 18/786,427

(22) Filed: Jul. 26, 2024

(30) Foreign Application Priority Data
Jul. 31, 2023 (CN) 202310953053.4

(51) Int. Cl. G06F 16/16; G06F 3/0482; G06F 3/0483

(52) U.S. Cl. CPC G06F 16/168; G06F 3/0482; G06F 3/0483

(57) ABSTRACT

The disclosure provides a method and apparatus, electronic device, and storage medium for processing information. The method for processing information includes: displaying a first directory, where the first directory includes at least two levels of directories, and the directories are directories in a document space and are associated with one or more documents; adding, in response to an add operation on the first directory, a first directory list corresponding to the first directory in a target document space, where the first directory is associated with a target document; and displaying, on the target document page, in response to a first type of operation on the first directory list, a first operation result after executing the first type of operation on the first directory list.

### CROSS-REFERENCE TO RELATED APPLICATION(S)

This application claims priority to Chinese Application No. 202310953053.4 filed Jul. 31, 2023, the disclosure of which is incorporated herein by reference in its entity.

### FIELD

The disclosure relates to the field of computer technology, and in particular to a method and apparatus, electronic device, and storage medium for processing information.

### BACKGROUND

With the increasing demand for collaborative office work, the technology of online document processing has gradually developed.

In current collaborative document processing applications, the content of child nodes under a current node is usually viewed and managed through a directory tree. The structure of the directory tree is displayed to all users, that is, every user sees the same structure of the directory tree, which cannot meet personalized use needs of the users for the directory tree.

### SUMMARY

In view of this, an objective of the disclosure provides a method and apparatus, electronic device, and storage medium for processing information.

Based on the above objective, in a first aspect, the disclosure provides a method for processing information, including:
displaying a first directory, where the first directory includes at least two levels of directories, and the directories are directories of a document space and are associated with one or more documents;
adding, in response to an add operation on the first directory, a first directory list corresponding to the first directory in a target document page, where the first directory is associated with a target document; and
displaying, on the target document page, in response to a first type of operation on the first directory list, a first operation result after executing the first type of operation on the first directory list.

In some embodiments, the at least two levels of directories include a first-level directory and at least one second-level directory, where the second-level directory is a subdirectory of the first-level directory, and the target document page includes a first document page corresponding to the first-level directory.

The adding, in response to an add operation on the first directory, a first directory list corresponding to the first directory in a target document page includes:
displaying, in response to the add operation on the first document page, a second directory list corresponding to the second-level directory on the first document page, where list entries in the second directory list are in one-to-one correspondence with directory entries in the second-level directory.

In some embodiments, the adding, in response to an add operation on the first directory, a first directory list corresponding to the first directory in a target document page includes:
displaying an add control in response to a trigger operation on the first directory; and
displaying the first directory list on the target document page in response to a trigger operation on the add control.

In some embodiments, the displaying, on the target document page, in response to a first type of operation on the first directory list, a first operation result of executing the first type of operation on the first directory list includes:
displaying, in response to a filtering operation on the second directory list, list entries of the second directory list after executing the filtering operation based on a preset filtering condition on the first document page.

In some embodiments, on the target document page, the displaying, in response to a first type of operation on the first directory list, a first operation result of executing the first type of operation on the first directory list includes:
displaying, in response to a sorting operation on the second directory list, list entries of the second directory list after executing the sorting operation based on a preset sorting condition on the first document page.

In some embodiments, the displaying, on the target document page, in response to a first type of operation on the first directory list, a first operation result of executing the first type of operation on the first directory list includes:
displaying, in response to a field configuration operation on the second directory list, a configured field on the first document page, and a field value corresponding to the configured field in the second directory list.

In some embodiments, the method further includes:
displaying, on the first directory and the target document page, in response to a second type of operation on the first directory list, a second operation result of executing the second type of operation on the first directory list.

In some embodiments, the displaying, on the first directory and the target document page, in response to a second type of operation on the first directory list, a second operation result of executing the second type of operation on the first directory list includes:
moving, in response to a moving operation on at least one target list entry in the second directory list, the at least one target list entry to a target position in the second directory list, and moving a directory entry of a second-level directory corresponding to the at least one target list entry in the first directory to a target position.

In some embodiments, the displaying, on the first directory and the target document page, in response to a second type of operation on the first directory list, a second operation result of executing the second type of operation on the first directory list includes:
creating, in response to a copy creation operation on at least one target list entry in the second directory list, a copy file corresponding to the at least one target list entry, displaying a copy list entry corresponding to the copy file in the second directory list, and displaying a copy directory entry corresponding to the copy file in the first directory.

In some embodiments, the displaying, on the first directory and the target document page, in response to a second type of operation on the first directory list, a second operation result of executing the second type of operation on the first directory list includes:
deleting, in response to a delete operation on at least one target list entry in the second directory list, a file corresponding to the at least one target list entry, canceling the display of the at least one target list entry in the second directory list, and canceling the display of a directory entry of a second-level directory corresponding to the at least one target list entry in the first directory.

In some embodiments, the displaying, on the first directory and the target document page, in response to a second type of operation on the first directory list, a second operation result of executing the second type of operation on the first directory list includes:
creating, in response to a creation operation on the second directory list, a target file, displaying a newly created list entry corresponding to the target file in the second directory list, and displaying a newly created directory entry corresponding to the newly created list entry in the first directory.

In some embodiments, the displaying, on the first directory and the target document page, in response to a second type of operation on the first directory list, a second operation result of executing the second type of operation on the first directory list includes:
uploading, in response to an upload operation on the second directory list, a target file, displaying an uploaded list entry corresponding to the target file in the second directory list, and displaying an uploaded directory entry corresponding to the uploaded list entry in the first directory.

In some embodiments, the displaying, on the first directory and the target document page, in response to a second type of operation on the first directory list, a second operation result of executing the second type of operation on the first directory list includes:
modifying, in response to a transfer operation on a target list entry in the second
directory list, an owner of a file corresponding to the target list entry.

In some embodiments, further includes, prior to responding to the second type of operation on the first directory list:
marking, in response to a single or multiple selection operation on the second directory list, one or more selected list entries in the second directory list.

In some embodiments, the method further includes:
displaying, in response to a view switching operation on the second directory list, a view corresponding to the second directory list on the first document page.

In some embodiments, the first-level directory includes at least one of a document directory entry, a folder directory entry, and an image directory entry, and the second-level directory includes at least one of a document directory entry, a folder directory entry, and an image directory entry.

In some embodiments, the first document page includes a plurality of unit blocks; and the method further includes:
arranging a directory entry of the first-level directory on a first unit block, and arranging each directory entry of the second-level directory on a second unit block, where the second unit block is a sub-block of the first unit block.

In some embodiments, the target document page and the first directory are displayed in the same window.

In a second aspect, the disclosure provides an apparatus for processing information, including:
a display module, configured to display a first directory, where the first directory includes at least two levels of directories, and the directories are directories in a document space and are associated with one or more documents;
an add module, configured to add, in response to an add operation on a first-level directory, a target list corresponding to a second-level directory to a first document page corresponding to the first-level directory, where the first directory is associated with a target document; and
an operation module, configured to display, in response to a first type of operation on the target list, a first operation result after executing the first type of operation on the target list on the first document page.

In a third aspect, the disclosure provides an electronic device, including a memory, a processor, and a computer program stored on the memory and executable on the processor. When the processor executes the program, the method for processing information in the first aspect is implemented.

In a fourth aspect, the disclosure provides a non-transitory computer-readable storage medium, storing computer instructions. The computer instructions are configured to cause the computer to execute the method for processing information in the first aspect.

It can be seen from the above that according to the method and apparatus, the electronic device, and the storage medium for processing information provided by the disclosure, by adding the first directory in the target document page, the first directory list corresponding to the first directory is formed on the target document page. When the user wants to perform operations on the first directory, instead of directly operating the first directory in the directory tree, the user can perform the first type of operation on the first directory list on the target document page that corresponds to the first directory, and therefore the operation result can only be displayed on the target document page without affecting the display of the first directory in the directory tree, thereby satisfying the personalized needs of the user without affecting use of the other users, and improving user experience.

### BRIEF DESCRIPTION OF THE DRAWINGS

In order to describe the technical solutions of the disclosure or the related art more clearly, the accompanying drawings required for describing the embodiments or the related art will be briefly introduced below. Apparently, the accompanying drawings in the following description are merely embodiments of the disclosure, and those of ordinary skill in the art may also obtain other accompanying drawings according to these accompanying drawings without creative efforts.

FIG. 1 illustrates a schematic flowchart of an exemplary method according to an embodiment of the disclosure.

FIG. 2a illustrates a schematic diagram of an exemplary page according to an embodiment of the disclosure.

FIG. 2b illustrates a schematic diagram of an exemplary page according to an embodiment of the disclosure.

FIG. 2c illustrates a schematic diagram of an exemplary page according to an embodiment of the disclosure.

FIG. 2d illustrates a schematic diagram of an exemplary page according to an embodiment of the disclosure.

FIG. 2e illustrates a schematic diagram of an exemplary page according to an embodiment of the disclosure.

FIG. 2f illustrates a schematic diagram of an exemplary page according to an embodiment of the disclosure.

FIG. 2g illustrates a schematic diagram of an exemplary page according to an embodiment of the disclosure.

FIG. 2h illustrates a schematic diagram of an exemplary page according to an embodiment of the disclosure.

FIG. 2i illustrates a schematic diagram of an exemplary page according to an embodiment of the disclosure.

FIG. 2j illustrates a schematic diagram of an exemplary page according to an embodiment of the disclosure.

FIG. 3 illustrates a schematic diagram of an exemplary apparatus according to an embodiment of the disclosure.

FIG. 4 illustrates a schematic diagram of a hardware structure of an exemplary computer device according to an embodiment of the disclosure.

### DETAILED DESCRIPTION OF EMBODIMENTS

To have an clearer understanding of objectives, technical solutions, and advantages of the disclosure, the disclosure is further described in detail in conjunction with specific embodiments and with reference to the accompanying drawings below.

It should be noted that unless otherwise defined, the technical or scientific terms used in the embodiments of the disclosure should have ordinary meanings understood by those of ordinary skill in the art of the disclosure. “First”, “second”, and similar words used in the embodiments of the disclosure are merely used for distinguishing different components instead of representing any sequence, quantity, or importance. Similar words such as “comprise” or “include” are intended to indicate that elements or objects appearing in front of the word cover elements or objects listed behind the word, as well as equivalents without excluding other elements or objects. Similar words such as “connected” or “linked” are not limited to physical or mechanical connections, but may include electrical connections, regardless of direct connections or indirect connections. “Upper”, “lower”, “left”, “right”, etc. are merely used for representing a relative positional relationship, and after the absolute position of a described object changes, the relative positional relationship may correspondingly change.

As mentioned in the background, when the users manage documents using the directory tree, the sorting of each directory entry in the directory tree is actively managed. The sorting of the directory entries seen by every user is fixed, and the users cannot filter and sort the directory documents based on personal needs.

In view of this, an embodiment of the disclosure provides a method for processing information to solve the above problems.

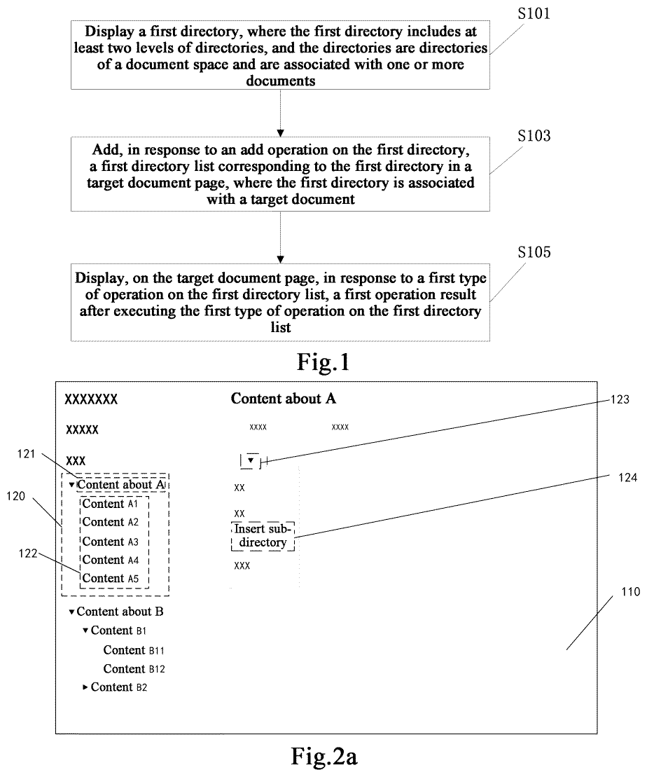

As shown in FIG. 1, the method for processing information includes:

Step S101: a first directory is displayed, where the first directory includes at least two levels of directories, and the directories are directories in a document space and are associated with one or more documents.

The document space may be a space located on a server, and configured to store and manage a plurality of cloud documents.

The first directory may be at least a portion of directory structure within the directory tree, including at least two levels of directories. The directory may be associated with one or more documents. For example, at least part of directory entries in the directory are associated with documents, and the corresponding directories may be viewed and managed through the directory entries associated with the documents.

In this embodiment, the first directory is also associated with one or more documents, and therefore the documents under the first directory may be viewed and managed through the first directory. The documents may include text documents, spreadsheets, presentations, and other file types.

Step S103: a first directory list corresponding to the first directory is added in a target document page in response to an add operation on the first directory, where the first directory is associated with a target document.

In this embodiment, the target document is a document associated with the first directory and includes the target document page. By performing the add operation on the first directory and adding the first directory list corresponding to the first directory in the target document page, the first directory is displayed within the target document page. The first directory list corresponds to the added first directory, including that list entries in the first directory list are the same as directory entries in the first directory, and an association relationship between the list entries in the first directory list is identical to an association relationship between the directory entries in the first directory. The association relationship may include a relationship between nodes, such as a relationship between parent and child nodes, sibling nodes, etc., which is not limited in this embodiment.

Step S105: in response to a first type of operation on the first directory list, a first operation result after executing the first type of operation on the first directory list is displayed on the target document page.

The first type of operation includes operations that do not change the structure and content of the first directory list. That is, through the first type of operation, addition, modification, or deletion of the directory entries in the first directory list is avoided while the association relationship between the directory entries is not changed. The first type of operation may include filtering, sorting, configuring display fields, etc.

After displaying the first directory list on the target document page, the first type of operation may be performed on the first directory list on the target document page. The first directory list on the target document page may be correspondingly changed after being subjected to the first type of operation, thereby satisfying the personalized needs of the current user. However, since the first type of operation cannot change the structure and content of the first directory list, performing the first type of operation on the first directory list cannot affect the display of the first directory in the directory tree and other users of the first directory, thereby enhancing user experience.

In this embodiment, by adding the first directory in the target document page, the first directory list corresponding to the first directory is formed on the target document page. When the user wants to perform operations on the first directory, instead of directly operating the first directory in the directory tree, the user can perform the first type of operation on the first directory list on the target document page that corresponds to the first directory, and therefore the operation result can only be displayed on the target document page without affecting the display of the first directory in the directory tree, thereby satisfying the personalized needs of the user without affecting use of the other users, and improving user experience.

In some embodiments, the at least two levels of directories include a first-level directory and at least one second-level directory, where the second-level directory is a subdirectory of the first-level directory.

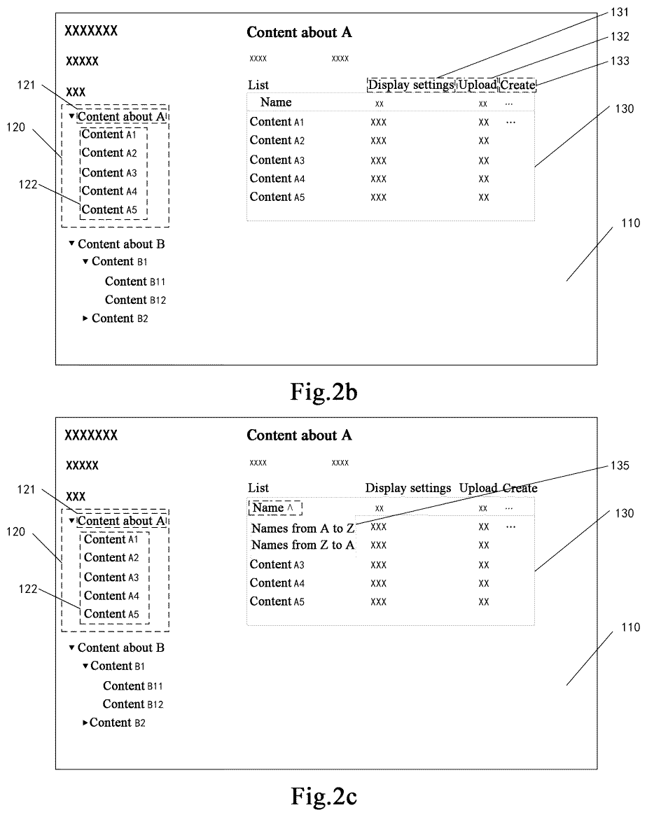

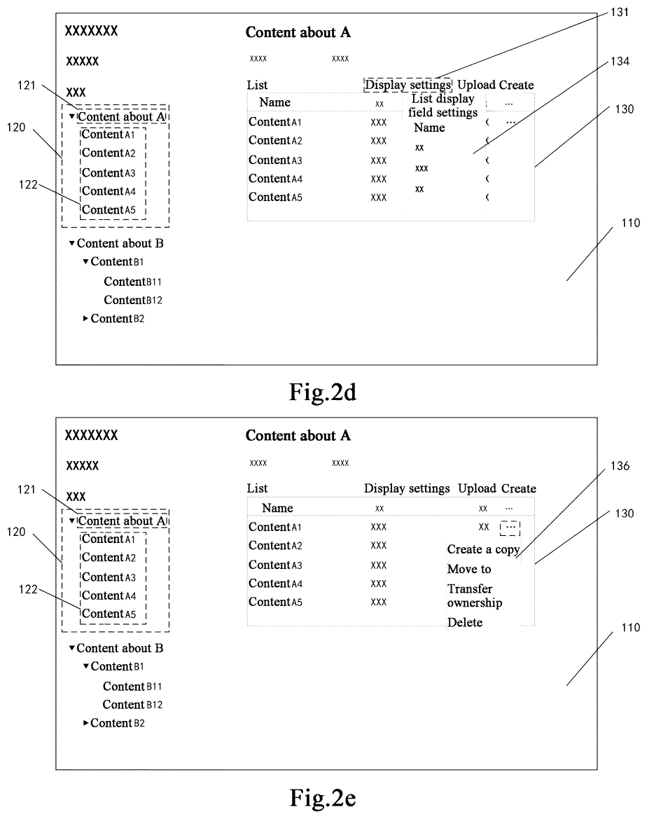

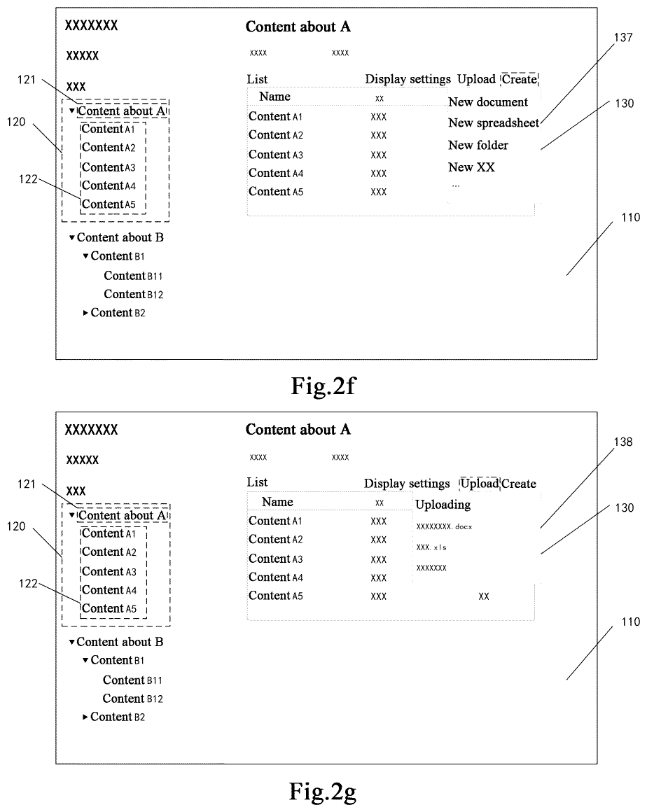

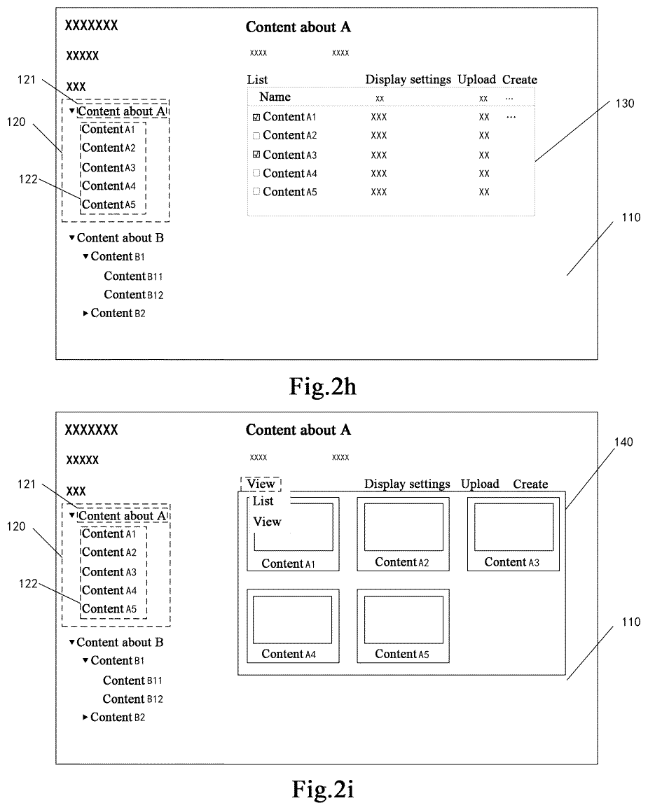

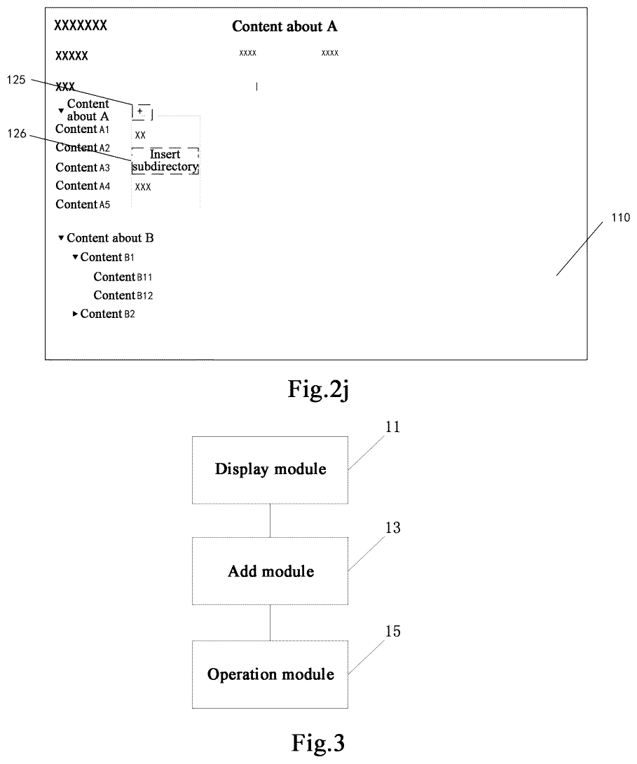

In this embodiment, as shown in FIG. 2a, the first directory 120 includes at least two levels of directories. The at least two levels of directories include a first-level directory 121 and at least one second-level directory 122. The second-level directory 122 is a subdirectory of the first-level directory 121. The second-level directory 122 may include at least one directory entry. The directory entries of the second-level directory 122 may include, for example, “Content A1”, “Content A2”, “Content A3”, “Content A4”, and “Content A5”.

In some embodiments, the two levels of directories may also include at least one third-level directory. The third-level directory is a subdirectory of the second-level directory. The third-level directory may include at least one directory entry. Optionally, the third-level directory may further include at least one subdirectory, which is not limited in this embodiment.

In some embodiments, the target document page includes a first document page 110 corresponding to the first-level directory. The first document page 110 may be used for displaying relevant information about the first-level directory, such as the title of the first-level directory “Content about A”, a creator, an editor, a creation time, description information, and other information. This embodiment does not impose limitations on this.

Optionally, the document content may also be edited on the first document page, such as adding a document cover, writing document content, adding other document components, etc. This embodiment does not impose limitations on this.

Optionally, the target document page may be a page of other types, such as a cloud document page created in a collaborative document processing application, or a page in another application that can communicate with the directory tree, such as a web page and a conversation page. This embodiment does not impose limitations on this.

Step S103 that a first directory list corresponding to the first directory is added in a target document page in response to an add operation on the first directory includes: a second directory list corresponding to the second-level directory is displayed on the first document page in response to the add operation on the first document page, where list entries in the second directory list are in one-to-one correspondence with the directory entries in the second-level directory.

In this embodiment, the add operation on the first directory may be achieved through the add operation on the first document page. That is, when the user performs the operation of adding the first directory to the first document page corresponding to the first-level directory, the second directory list corresponding to the second-level directory may be displayed on the first document page, where the list entries in the second directory list are in one-to-one correspondence with the directory entries in the second-level directory, such that the second directory list displayed on the first document page is identical to the first directory.

As shown in FIG. 2a, the first document page 110 may display a first control 123 configured to perform the add operation. When the user triggers the first control 123, a second control 124 configured to add directories may be displayed. When the user triggers the second control 124, a second directory list 130 corresponding to the second-level directory 122 may be displayed on the first document page 110, as shown in FIG. 2b.

In some embodiments, the step that a first directory list corresponding to the first directory is added in a target document page includes:

Step S201: an add control is displayed in response to the trigger operation on the first directory.

Step S203: the first directory list is displayed on the target document page in response to the trigger operation on the add control.

In this embodiment, the user can directly operate the first directory so as to add the first directory list corresponding to the first directory in the target document page.

As shown in FIG. 2j, when the user triggers the first directory, such as right-clicking on the first directory or triggering a control 125 on the first directory, an add control 126 may be displayed at an associated position of the first directory. When the user triggers the add control 126, the first directory list corresponding to the first directory can be displayed on the target document page.

The user triggering the first directory may be the user triggering a target directory entry of the first directory. The target directory entry may be a first-level directory of the first directory, or a certain directory entry of a second-level directory of the first directory, which is not limited in this embodiment.

Correspondingly, the target document page is a page associated with the target directory entry, such as a second document page corresponding to the target directory entry, which is not limited in this embodiment. In this embodiment, when the user triggers the target directory entry, the add control 126 corresponding to the target directory entry is displayed.

The user triggers the add control 126, such that a directory list corresponding to a subdirectory of the target directory entry can be displayed on the second document page, or the directory list including the target directory entry and the subdirectory corresponding to the target directory entry is displayed on the second document page.

In some embodiments, when the at least two levels of directories further include a third-level directory and other various levels of subdirectories and the operation of adding the first directory is performed on the first document page, a directory list corresponding to the third-level directory and other various levels of subdirectories may also be displayed on the first document page, where the list entries of the target directory are also in one-to-one correspondence with directory entries of the third-level directory and other various levels of subdirectories. The third-level directory is a subdirectory of the second-level directory. The third-level directory may include at least one directory entry.

Optionally, the third-level directory may further include a subdirectory, which is not limited in this embodiment.

In some embodiments, step S105 that in response to a first type of operation on the first directory list, a first operation result of executing the first type of operation on the first directory list is displayed on the target document page includes: in response to a filtering operation on the second directory list, list entries of the second directory list after executing the filtering operation based on a preset filtering condition are displayed on the first document page.

In this embodiment, the filtering operation may be performed on the second directory list on the first document page based on the preset filtering condition, a filtering result is displayed on the first document page and cannot affect the display of the various directory entries in the first directory, thereby satisfying the personalized display needs of the user without affecting use of the other users of the first directory, and improving user experience. The user may set the filtering condition based on field values of various fields in the list entries, which is not limited in this embodiment.

In some embodiments, step S105 that in response to a first type of operation on the first directory list, a first operation result of executing the first type of operation on the first directory list is displayed on the target document page includes: displaying, on the first document page, in response to a sorting operation on the second directory list, list entries of the second directory list after executing the sorting operation based on a preset sorting condition.

In this embodiment, a sorting operation may be performed on the second directory list on the first document page based on a sorting condition, and a sorting result is displayed on the first document page and cannot affect the display of the various directory entries in the first directory, thereby satisfying the personalized display needs of the user without affecting use of the other users of the first directory, and improving user experience. The user may set the sorting condition based on the various fields in the list entries, which is not limited in this embodiment.

As shown in FIG. 2c, various list entries may be sorted based on the field “Name” in the second directory list 130, or may also be sorted based on other fields, which is not limited in this embodiment.

In some embodiments, step S105 that in response to a first type of operation on the first directory list, a first operation result of executing the first type of operation on the first directory list is displayed on the target document page includes: in response to a field configuration operation on the second directory list, a configured field is displayed on the first document page, and a field value corresponding to the configured field is displayed in the second directory list.

In this embodiment, the user may configure the field displayed in the second directory list on the first document page, the configured field is displayed on the first document page, the field value corresponding to the field is displayed in the list entries, and therefore the user can know more information of the list entries in the first directory. Meanwhile, the field configuration cannot affect the display of the various directory entries in the first directory, thereby satisfying the personalized display needs of the user without affecting use of the other users of the first directory, and improving user experience.

As shown in FIG. 2d, when the user triggers a display setting control 131 on the first document page 110, which is used for implementing list display field settings, a list display field setting window 134 may be displayed on the first document page 110. The list display field setting window 134 may show fields in the list. Based on the configuration of the user on each field in the list display field setting window 134, the fields selected by the user may be displayed on the second directory list, thereby displaying more information related to the directory tree. Compared with the direct display in the directory tree, in this embodiment, more space is included on the first document page 110 to display of each directory entry, facilitating user usage.

In some embodiments, after step S103 that a first directory list corresponding to the first directory is added in a target document page in response to an add operation on the first directory, the method further includes:

Step S107: in response to a second type of operation on the first directory list, a second operation result of executing the second type of operation on the first directory list is displayed on the first directory and the target document page.

The second type of operation includes operations that may change the structure or content of the first directory list. That is, through the second type of operation, the directory entries in the first directory list may be added, modified, and deleted, or the association relationship between the directory entries may be changed. The second type of operation may include operations such as moving, creating copies, deleting, creating, uploading, etc.

In this embodiment, after the first directory list is displayed on the target document page, the second type of operation may be performed on the first directory list on the target document page. The first directory list on the target document page may be correspondingly changed after being subjected to the second type of operation, thereby satisfying the personalized needs of the current user. However, since the second type of operation may change the structure or content of the first directory list, performing the second type of operation on the first directory list may affect the display of the first directory in the directory tree. Therefore, the first directory in the directory tree may be correspondingly changed to ensure consistency between the first directory list and the first directory in the directory tree, facilitating the user to implement subsequent operations on the first directory based on the first directory list on the first document page.

In some embodiments, step S107 that in response to a second type of operation on the first directory list, a second operation result of executing the second type of operation on the first directory list is displayed on the first directory and the target document page includes: in response to a moving operation on at least one target list entry in the second directory list, the at least one target list entry is moved to a target position in the second directory list, and a directory entry of a second-level directory corresponding to the at least one target list entry in the first directory is moved to the target position.

In a target tree, the user may change a parent node of the directory entry through the moving operation on a certain directory entry. For example, in the first directory, the user may move a certain child node (i.e., a directory entry of the second-level directory) belonging to a first-level directory A to a first-level directory B from the first-level directory A, thereby achieving the moving operation on the directory entry.

In this embodiment, the user may perform the moving operation on the target list entry in the second directory list on the first document page, and when the target list entry is moved to the target position in the second directory list, the directory entry of the second-level directory corresponding to the target list entry may also be moved to the target position in the first directory, thereby ensuring consistency between the second directory list and the first directory in structure and content, and facilitating the user to implement subsequent operations on the first directory based on the second directory list on the first document page.

As shown in FIG. 2e, when the user selects at least one list entry on the first document page 110 and triggers a corresponding control, a window 136 may be displayed. The window includes a move control that allows the user to move the selected list entry to the target position. When the user triggers the move control, the selected list entry may be moved to the target position.

In some embodiments, step S107 that in response to a second type of operation on the first directory list, a second operation result of executing the second type of operation on the first directory list is displayed on the first directory and the target document page includes: in response to a copy creation operation on at least one target list entry in the second directory list, a copy file corresponding to the at least one target list entry is created, a copy list entry corresponding to the copy file is displayed in the second directory list, and a copy directory entry corresponding to the copy file is displayed in the first directory.

In the target tree, the user may perform the copy creation operation based on the various directory entries in the directory tree. After copy creation based on the directory tree, the corresponding copy file may be created and stored in the system, and the copy directory entry corresponding to the copy file may also be displayed in the directory tree.

In this embodiment, the user may also perform the copy creation operation through the second directory list on the first document page, the corresponding copy file may also be created and stored in the system based on the copy creation operation, and the copy list entry corresponding to the copy file is displayed in the second directory list. Meanwhile, the copy directory entry corresponding to the copy file is displayed in the first directory, and the copy directory entry is also a copy directory entry of the directory entry of the second-level directory corresponding to the target list entry in the first directory, thereby ensuring consistency between the second directory list and the first directory in structure and content, and facilitating the user to implement subsequent operations on the first directory based on the second directory list on the first document page.

As shown in FIG. 2e, after the user selects at least one list entry on the first document window includes a copy creation control that allows the user to perform copy creation on the selected list entry, and when the user triggers the copy creation control, a corresponding copy may be created for the selected list entry.

In some embodiments, step S107 that in response to a second type of operation on the first directory list, a second operation result of executing the second type of operation on the first directory list is displayed on the first directory and the target document page includes: in response to a delete operation on at least one target list entry in the second directory list, a file corresponding to the at least one target list entry is deleted, the display of the at least one target list entry in the second directory list is canceled, and the display of the directory entry of the second-level directory corresponding to the at least one target list entry in the first directory is canceled.

In the target tree, the user may perform the delete operation based on the various directory entries of the directory tree, and after the delete operation is performed, the deleted directory entry is not displayed in the directory tree, and a file corresponding to the deleted directory entry is deleted as well. File deletion may include complete file deletion, or deletion of a path pointing to a file storage location, which is not limited in this embodiment. In this embodiment, the user may also perform the delete operation through the second directory list on the first document page, may also delete the corresponding file in the system based on the delete operation, and cancels the display of the deleted target list entry in the second directory list. Meanwhile, the display of the directory entry of the second-level directory corresponding to the deleted target directory list entry is canceled in the first directory, thereby ensuring consistency between the second directory list and the first directory in structure and content, and facilitating the user to implement subsequent operations on the first directory based on the second directory list on the first document page.

As shown in FIG. 2e, after the user selects at least one list entry on the first document page 110 and triggers a corresponding control, the window 136 may be displayed. The window includes a delete control that allows the user to perform the delete operation on the selected list entry, and when the user triggers the delete control, the selected list entry and a corresponding file can be deleted.

In some embodiments, step S107 that in response to a second type of operation on the first directory list, a second operation result of executing the second type of operation on the first directory list is displayed on the first directory and the target document page includes: in response to a creation operation on the second directory list, a target file is created, a newly created list entry corresponding to the target file is displayed in the second directory list, and a newly created directory entry corresponding to the newly created list entry is displayed in the first directory.

In the target tree, the user may create a file based on the directory tree, and after the creation operation is performed, a new file may be created in the system, and a newly created directory entry corresponding to the created file is displayed in the directory tree.

In this embodiment, the user may also perform the file creation operation through the second directory list on the first document page, the corresponding target file may be created in the system based on the creation operation of the created file, the newly created list entry corresponding to the target file is displayed in the second directory list, and meanwhile, the newly created directory entry corresponding to the target file is displayed in the first directory as well, thereby ensuring consistency between the second directory list and the first directory in structure and content, and facilitating the user to implement subsequent operations on the first directory based on the second directory list on the first document page.

As shown in FIG. 2f, the first document page 110 displays a new creation control for creating files. When the user triggers the new creation control, the first document page 110 displays a window 137 for file creation, and based on the window 137 for file creation, the user may create documents, spreadsheets, slideshows, folders, images, etc.

A file at the same level as the list entry in the second directory list may be created, and therefore the newly created directory entry is a subdirectory entry of the first-level directory; or a subfile of the list entry in the second directory list may also be created, and therefore the newly created directory entry is a subdirectory entry of the second-level directory, which is not limited in this embodiment.

In some embodiments, step S107 that in response to a second type of operation on the first directory list, a second operation result of executing the second type of operation on the first directory list is displayed on the first directory and the target document page includes: in response to an upload operation on the second directory list, a target file is uploaded, an uploaded list entry corresponding to the target file is displayed in the second directory list, and an uploaded directory entry corresponding to the uploaded list entry is displayed in the first directory.

In the target tree, the user may import a file based on the directory tree, and after an import operation is performed, a new file may be added to the system, and an imported directory entry corresponding to the added file is displayed in the directory tree.

In this embodiment, the user may also perform the file import operation through the second directory list on the first document page, and may add the corresponding target file to the system based on the import operation for file import. The uploaded list entry corresponding to the target file is displayed in the second directory list, and meanwhile, the uploaded directory entry corresponding to the target file, namely the uploaded list entry is displayed in the first directory as well, thereby ensuring consistency between the second directory list and the first directory in structure and content, and facilitating the user to implement subsequent operations on the first directory based on the second directory list on the first document page.

As shown in FIG. 2g, the first document page 110 displays an upload control for file import. When the user triggers the upload control, the first document page 110 displays a file upload window 138, and the file upload window 138 may display information such as a list of files being uploaded, progress, and types.

A file at the same level as the list entry in the second directory list may be uploaded, and therefore the uploaded directory entry is a subdirectory entry of the first-level directory; or a subfile of the list entry in the second directory list may also be uploaded, and therefore the uploaded directory entry is a subdirectory entry of the second-level directory, which is not limited in this embodiment.

In some embodiments, step S107 that in response to a second type of operation on the first directory list, a second operation result of executing the second type of operation on the first directory list is displayed on the first directory and the target document page includes: in response to a transfer operation on the target list entry in the second directory list, an owner of a file corresponding to the target list entry is modified.

In the target tree, the user may transfer ownership permissions of the owner of various files within the directory tree based on the directory tree. In this embodiment, the user may also perform the transfer operation on the target list entry through the second directory list on the first document page, so as to modify the owner of the file corresponding to the target list entry, thereby ensuring consistency between the second directory list and the first directory in structure and content, and facilitating the user to implement subsequent operations on the first directory based on the second directory list on the first document page.

As shown in FIG. 2e, after the user selects at least one list entry on the first document window includes an ownership transfer control that allows the user to perform the transfer operation on the selected list entry. When the user triggers the ownership transfer control, the selected list entry and a corresponding file are transferred from one owner to another.

In the above embodiments, the operations such as moving, creating copies, deleting, creating, uploading, and transferring performed on the first directory list directly affect the first directory and the various files in the first directly. That is, in this embodiment, the first directory may be changed through the operations on the first directory list on the first document page. Typically, the space of the first document page is larger than the space occupied by the first directory. Therefore, changing the first directory through the operations on the first directory list on the first document page is more convenient than directly modifying the first directory, thereby enhancing user experience.

In some embodiments, before the user performs the operations such as moving, creating copies, deleting, creating, uploading, or transferring on the first directory list, the method further includes: in response to a single or multiple selection operation on the second directory list, one or more selected list entries are marked in the second directory list.

In this embodiment, as shown in FIG. 2h, before the user performs the operations such as moving, creating copies, deleting, creating, uploading, or transferring, one or more list entries may be selected for the implementation. Compared with the direct independent implementation of the operations such as moving, creating copies, deleting, creating, uploading, or transferring in the first directory, the operation is more convenient, thereby improving user experience.

In some embodiments, the method further includes: in response to a view switching operation on the second directory list, a view corresponding to the second directory list is displayed on the first document page.

In this embodiment, as shown in FIG. 2i, a view style of the second directory list may be switched on the first document page, facilitating the user to view different visual effects and then improving user experience. In some embodiments, the first-level directory includes at least one of a document directory entry, a folder directory entry, and an image directory entry, and the second-level directory includes at least one of a document directory entry, a folder directory entry, and an image directory entry.

When both the first-level directory and the second-level directory include the document directory entry, an effect of documents mounted on documents is achieved, thereby satisfying more use requirements of the user.

In some embodiments, the first document page includes a plurality of unit blocks. The method further includes: a directory entry of the first-level directory is arranged on a first unit block, and each directory entry of the second-level directory is arranged on a second unit block, where the second unit block is a sub-block of the first unit block.

In this embodiment, the first document page may store page information in the form of unit blocks. Accordingly, when the first directory is added to the first document page, each directory entry of the first-level directory is arranged on one first unit block, each directory entry of the second-level directory is arranged on one second unit block, and the second unit block is set as the sub-block of the first unit block, thereby realizing a parent-child relationship and a sibling relationship between various nodes in the first directory through a parent-child relationship and a sibling relationship between the unit blocks, achieving data interaction between the first document page and the first directory, and then ensuring consistency between the first directory list on the first document page and the first directory in the directory tree.

For example, when the first document page is a cloud document page, the unit block is a document block. Each directory entry of the first-level directory is arranged on one first document block, each directory entry of the second-level directory is arranged on one second document block, and the second document block is set as a sub-block of the first document block, thereby realizing the parent-child relationship and the sibling relationship between various nodes in the first directory through a parent-child relationship and a sibling relationship between the document blocks, achieving data interaction between the first document page and the first directory, and then ensuring consistency between the first directory list on the first document page and the first directory in the directory tree.

In some embodiments, when the first document page is a cloud document page, a document management component may store the first directory list and communicates with the first directory. The user may perform, through the document management component, filtering, sorting, viewing, and field configuration on the nodes under the first directory, every user may perform filtering, sorting, and field configuration as needed, these operations cannot affect the first directory, and the personalized operation requirements of the user are satisfied without affecting use of the other users. The user may also perform, through the document management component, operations such as newly adding, deleting, moving, creating copies, and transferring ownership on the various nodes in the first directory, and these operations may affect the first directory, thereby ensuring consistency between the first directory in the directory tree and the first directory list in the document management component. Due to a larger operable space on the first document page, the user views and manages the first directory through the document management component more efficiently and conveniently compared with the direct operation on the first directory in the directory tree.

In some embodiments, as shown in FIG. 2a to FIG. 2h, the target document page and the first directory are displayed in the same window, facilitating user viewing and use by the user.

In the above embodiment, when the target document page displays the first directory list corresponding to the first directory, the user may perform filtering, sorting, viewing, and field configuration on the nodes under the first directory on the target document page. Every user may perform filtering, sorting, and field configuration as needed. These operations cannot affect the first directory. The personalized operation requirements of the user are satisfied without affecting use of the other users. Because the first directory list on the target document page communicates with the first directory in the directory tree. The user may also perform operations such as newly adding, deleting, moving, creating copies, and transferring ownership on the various nodes in the first directory on the target document page, and these operations may affect the first directory, thereby ensuring consistency between the first directory in the directory tree and the first directory list on the target document page. Due to a larger operable space on the first document page, the user views and manages the first directory on the target document page more efficiently and conveniently compared with the direct operation on the first directory in the directory tree.

It should be noted that the methods in the embodiments of the disclosure may be performed by a single device, such as a computer or server. The method in this embodiment may also be applied to a distributed scenario to be completed through cooperation of a plurality of devices. In the distributed scenario, one of the plurality of devices may only perform one or more steps of the method in the embodiments of the disclosure. The plurality of devices interact with each another to complete the method.

It should be noted that some embodiments of the disclosure are described above.

Other embodiments are within the scope of the appended claims. In some cases, the actions or steps recorded in the claims may be performed in an order different from that in the foregoing embodiments, and can still achieve desired results. In addition, the processes depicted in the accompanying drawings do necessarily require a specific or consecutive order shown to achieve the desired results. In some implementations, multi-task processing and parallel processing are also possible or may be advantageous.

It should be understood that before using the technical solutions of the embodiments in the disclosure, users are properly informed about the types, application range, usage scenarios, etc. of involved personal so as to obtain authorizations of the users.

For example, in response to receiving an active request of the user, a prompt message is sent to the user to clearly indicate the user that it is necessary to obtain and use the personal information of the user for the operation requested to be performed. Therefore, the user may freely select, according to the prompt message, whether to provide the personal information for the software or hardware such as an electronic device, an application, a server, or a storage medium executing the operations of the technical solutions of the disclosure.

As an optional but non-limiting implementation, the manner of sending the prompt message to the user in response to receiving the active request of the user may be, for example, a form of a pop-up window, and the prompt message may be represented within the pop-up window in a text form. Additionally, the pop-up window may further carry a selection control for the user to choose whether to “agree” or “disagree” to provide the personal information for the electronic device.

It should be understood that the above notification and user authorization obtaining process is only illustrative, which does not limit the implementations of the disclosure, and other methods that comply with relevant laws and regulations may also be applied to the implementations of the disclosure.

Based on the same inventive concept, corresponding to the method in any one of the foregoing embodiments, the disclosure further provides an information processing apparatus.

Referring to FIG. 3, the apparatus includes:
a display module 11, configured to display a first directory, where the first directory includes at least two levels of directories, and the directories are directories in a document space and are associated with one or more documents;
an add module 13, configured to add, in response to an add operation on a first-level directory, a target list corresponding to a second-level directory to a first document page corresponding to the first-level directory; and
an operation module 15, configured to display, in response to a first type of operation on the target list, a first operation result after executing the first type of operation on the target list on the first document page.

In some embodiments, the at least two levels of directories include a first-level directory and at least one second-level directory, where the second-level directory is a subdirectory of the first-level directory, and the target document page includes a first document page corresponding to the first-level directory.

The add module 13 is further configured to:
display, in response to the add operation on the first document page, a second directory list corresponding to the second-level directory on the first document page, where list entries in the second directory list are in one-to-one correspondence with directory entries in the second-level directory.

In some embodiments, the add module 13 is further configured to: display, in response to a trigger operation on the first directory, an add control; and display, in response to a trigger operation on the add control, the first directory list on the target document page.

In some embodiments, the operation module 15 is further configured to: display, in response to a filtering operation on the second directory list, list entries of the second directory list after executing the filtering operation based on a preset filtering condition on the first document page.

In some embodiments, the operation module 15 is further configured to: display, in response to a sorting operation on the second directory list, list entries of the second directory list after executing the sorting operation based on a preset sorting condition on the first document page.

In some embodiments, the operation module 15 is further configured to: display, in response to a field configuration operation on the second directory list, a configured field on the first document page, and a field value corresponding to the configured field in the second directory list.

In some embodiments, the operation module 15 is further configured to:
display, on the first directory and the target document page, in response to a second type of operation on the first directory list, a second operation result of executing the second type of operation on the first directory list.

In some embodiments, the operation module 15 is further configured to: move, in response to a moving operation on at least one target list entry in the second directory list, the at least one target list entry to a target position in the second directory list, and move a directory entry of a second-level directory corresponding to the at least one target list entry in the first directory to a target position.

In some embodiments, the operation module 15 is further configured to: create, in response to a copy creation operation on at least one target list entry in the second directory list, a copy file corresponding to the at least one target list entry, display a copy list entry corresponding to the copy file in the second directory list, and display a copy directory entry corresponding to the copy file in the first directory.

In some embodiments, the operation module 15 is further configured to: delete, in response to a delete operation on at least one target list entry in the second directory list, a file corresponding to the at least one target list entry, cancel the display of the at least one target list entry in the second directory list, and cancel the display of a directory entry of the second-level directory corresponding to the at least one target list entry in the first directory.

In some embodiments, the operation module 15 is further configured to: create, in response to a creation operation on the second directory list, a target file, display a newly created list entry corresponding to the target file in the second directory list, and display a newly created directory entry corresponding to the newly created list entry in the first directory.

In some embodiments, the operation module 15 is further configured to: upload, in response to an upload operation on the second directory list, a target file, display an uploaded list entry corresponding to the target file in the second directory list, and display an uploaded directory entry corresponding to the uploaded list entry in the first directory.

In some embodiments, the operation module 15 is further configured to: modify, in response to a transfer operation on a target list entry in the second directory list, an owner of a file corresponding to the target list entry.

In some embodiments, before the response to a second type of operation on the first directory list, the apparatus is further configured to:

mark, in response to a single or multiple selection operation on the second directory list, one or more selected list entries in the second directory list.

In some embodiments, the apparatus is further configured to:
display, in response to a view switching operation on the second directory list, a view corresponding to the second directory list on the first document page.

In some embodiments, the first-level directory includes at least one of a document directory entry, a folder directory entry, and an image directory entry, and the second-level directory includes at least one of a document directory entry, a folder directory entry, and an image directory entry.

In some embodiments, the first document page includes a plurality of unit blocks; and the apparatus is further configured to:
arrange a directory entry of the first-level directory on a first unit block, and arrange each directory entry of the second-level directory on a second unit block, where the second unit block is a sub-block of the first unit block.

For ease of description, the above apparatus is respectively described with various modules divided according to functions. Of course, during implementing the disclosure, the functions of the modules may be realized in the same one or more software and/or hardware.

The apparatus of the above embodiment is configured to implement the corresponding method for processing information in any one of the foregoing embodiments, and has the beneficial effects of the corresponding method embodiment. Details are not repeated here.

Based on the same inventive concept, corresponding to any one of the foregoing embodiment methods, the disclosure further provides an electronic device, including a memory, a processor, and a computer program stored on the memory and executable on the processor. When the processor executes the program, the method in any one of the foregoing embodiments is implemented.

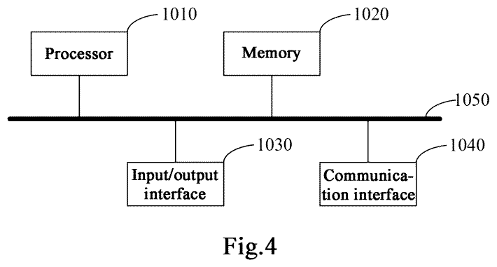

FIG. 4 illustrates a more specific hardware structure schematic diagram of an electronic device according to an embodiment. The device may include: a processor 1010, a memory 1020, an input/output interface 1030, a communication interface 1040, and a bus 1050. The processor 1010, the memory 1020, the input/output interface 1030, and the communication interface 1040 are mutually in communication connection in the device through the bus 1050.

The processor 1010 may be implemented using methods, such as a general-purpose central processing unit (CPU), a microprocessor, an application specific integrated circuit (ASIC), or one or more integrated circuits, which is configured to execute relevant programs to implement the technical solutions provided in the embodiments of this specification.

The memory 1020 may be implemented using forms, such as a read only memory (ROM), a random access memory (RAM), a static storage device, and a dynamic storage device. The memory 1020 may store an operating system and other applications. When the technical solutions provided in the embodiments of this specification are implemented through software or firmware, relevant program code is stored in the memory 1020, and invoked and executed by the processor 1010.

The input/output interface 1030 is configured to be connected with an input/output module to achieve information input and output. The input/output module may be configured as a component in the device (not shown in the figure), and may also be externally connected to the device to provide corresponding functions. An input device may include a keyboard, a mouse, a touchscreen, a microphone, various sensors, etc. An output device may include a display, a speaker, a vibrator, an indicator light, etc.

The communication interface 1040 is configured to be connected with a communication module (not shown in the figure) to achieve communication interaction between the device and other devices. The communication module may communicate through a wired method (e.g., USB and a cable) or a wireless method (e.g., a mobile network, WIFI, and Bluetooth).

The bus 1050 includes a pathway for transmitting information between various components of the device (e.g., the processor 1010, the memory 1020, the input/output interface 1030, and the communication interface 1040).

It should be noted that although the above device only shows the processor 1010, the memory 1020, the input/output interface 1030, the communication interface 1040, and the bus 1050, in the specific implementation process, the device may also include other components necessary for normal operation. In addition, those skilled in the art should understand that the device may also only include components necessary for implementing the solutions of the embodiments of this specification, and does not necessarily include all the components shown in the figures.

The electronic device of the above embodiment is configured to implement the corresponding method in any one of the foregoing embodiments, and has the beneficial effects of the corresponding method embodiment. Details are not repeated here.

Based on the same inventive concept, corresponding to any one of the foregoing embodiment methods, the disclosure further provides a non-transitory computer-readable storage medium storing computer instructions. The computer instructions are configured to enable the computer to perform the method in any one of the foregoing embodiments.

The computer-readable medium in this embodiment includes permanent and non-permanent, removable and non-removable media, which may implement information storage by any method or technology. Information may be computer-readable instructions, a data structure, a program module, or other data. Examples of the computer storage medium include, but are not limited to, a phase-change memory (PRAM), a static random access memory (SRAM), a dynamic random access memory (DRAM), another type of random access memory (RAM), a read only memory (ROM), an electrically erasable programmable read only memory (EEPROM), a flash memory or other memory technologies, a compact disc read only memory (CD-ROM), a digital versatile disc (DVD) or other optical storage, a magnetic cassette tape, a magnetic disk storage, or other magnetic storage devices, or any other non-transmission medium that can be configured to store information accessible to a computing device.

The computer instructions stored in the storage medium of the above embodiment are configured to enable the computer to perform the method in any one of the foregoing embodiments, and has the beneficial effects of the corresponding method embodiment. Details are not repeated here.

Those of ordinary skill in the art should understand that the discussion about any above embodiment is exemplary and is not intended to imply that the scope (including the claims) of the disclosure is limited to these examples; and under the idea of the disclosure, technical features in the foregoing embodiments or in different embodiments may also be combined, the steps may be implemented in any order, and many other variations of different aspects in the foregoing embodiments of the disclosure may exist, and for brevity, are not provided in detail.

In addition, to simplify the description and discussion, and to avoid making the embodiments of the disclosure difficult to understand, known power/ground connections to an integrated circuit (IC) chip and other components may or may not be shown in the provided accompanying drawings. Further, the apparatuses may be shown in the form of block diagrams to avoid making the embodiments of the disclosure difficult to understand. The following fact is also considered, that is, the details of the implementation of the apparatuses in these block diagrams are highly dependent on a platform on which the embodiments of the disclosure will be implemented (i.e., these details should be completely within the understanding scope of those skilled in the art). When the specific details (e.g., a circuit) are elaborated to describe the exemplary embodiments of the disclosure, it is apparent to those skilled in the art that the embodiments of the disclosure can be implemented without these specific details or with variations of these specific details. Therefore, these descriptions should be considered illustrative rather than restrictive.

Although the disclosure has been described in conjunction with the specific embodiments of the disclosure, many substitutions, modifications, and variations of these embodiments are apparent to those of ordinary skill in the art according to the foregoing descriptions. For example, other memory architectures (e.g., a dynamic RAM (DRAM)) may use the discussed embodiments.

The embodiments of the disclosure are intended to cover all such substitutions, modifications, and variations that fall within the broad scope of the appended claims. Therefore, any omissions, modifications, equivalent substitutions, improvements, etc., made within the spirit and principle of the embodiments of the disclosure should fall within the scope of protection of the disclosure.

I/We claim:

1. A method for processing information, comprising:
displaying a first directory, wherein the first directory comprises at least two levels of directories, and the directories are directories of a document space and are associated with one or more documents;
adding, in response to an add operation on the first directory, a first directory list corresponding to the first directory in a target document page, wherein the first directory is associated with a target document; and
displaying, on the target document page, in response to a first type of operation on the first directory list, a first operation result after executing the first type of operation on the first directory list.

2. The method according to claim 1, wherein the at least two levels of directories comprise a first-level directory and at least one second-level directory, wherein the second-level directory is a subdirectory of the first-level directory; and the target document page comprises a first document page corresponding to the first-level directory; and
wherein adding, in response to the add operation on the first directory, the first directory list corresponding to the first directory in the target document page comprises:
displaying, on the first document page, in response to an add operation on the first document page, a second directory list corresponding to the second-level directory, wherein list entries in the second directory list are in one-to-one correspondence with directory entries in the second-level directory.

3. The method according to claim 1, wherein adding, in response to the add operation on the first directory, the first directory list corresponding to the first directory in the target document page comprises:
displaying an add control in response to a trigger operation on the first directory; and
displaying the first directory list on the target document page in response to a trigger operation on the add control.

4. The method according to claim 2, wherein displaying, on the target document page, in response to the first type of operation on the first directory list, the first operation result of executing the first type of operation on the first directory list comprises:
displaying, on the first document page, in response to a filtering operation on the second directory list, list entries of the second directory list after executing the filtering operation based on a preset filtering condition.

5. The method according to claim 2, wherein displaying, on the target document page, in response to the first type of operation on the first directory list, the first operation result of executing the first type of operation on the first directory list comprises:
displaying, on the first document page, in response to a sorting operation on the second directory list, list entries of the second directory list after executing the sorting operation based on a preset sorting condition.

6. The method according to claim 2, wherein displaying, on the target document page, in response to the first type of operation on the first directory list, the first operation result after executing the first type of operation on the first directory list comprises:
displaying, in response to a field configuration operation on the second directory list, a configured field on the first document page, and a field value corresponding to the configured field in the second directory list.

7. The method according to claim 2, further comprising:
displaying, on the first directory and the target document page, in response to a second type of operation on the first directory list, a second operation result of executing the second type of operation on the first directory list.

8. The method according to claim 7, wherein displaying, on the first directory and the target document page, in response to the second type of operation on the first directory list, the second operation result of executing the second type of operation on the first directory list comprises:
moving, in response to a moving operation on at least one target list entry in the second directory list, the at least one target list entry to a target position in the second directory list, and moving a directory entry of a second-level directory corresponding to the at least one target list entry in the first directory to a target position.

9. The method according to claim 7, wherein displaying, on the first directory and the target document page, in response to the second type of operation on the first directory list, the second operation result of executing the second type of operation on the first directory list comprises:
creating, in response to a copy creation operation on at least one target list entry in the second directory list, a copy file corresponding to the at least one target list entry, displaying a copy list entry corresponding to the copy file in the second directory list, and displaying a copy directory entry corresponding to the copy file in the first directory.

10. The method according to claim 7, wherein displaying, on the first directory and the target document page, in response to the second type of operation on the first directory list, the second operation result of executing the second type of operation on the first directory list comprises:
deleting, in response to a delete operation on at least one target list entry in the second directory list, a file corresponding to the at least one target list entry, canceling a display of the at least one target list entry in the second directory list, and canceling a display of a directory entry of a second-level directory corresponding to the at least one target list entry in the first directory.

11. The method according to claim 7, wherein displaying, on the first directory and the target document page, in response to the second type of operation on the first directory list, the second operation result of executing the second type of operation on the first directory list comprises:
creating, in response to a creation operation on the second directory list, a target file, displaying a newly created list entry corresponding to the target file in the second directory list, and displaying a newly created directory entry corresponding to the newly created list entry in the first directory.

12. The method according to claim 7, wherein displaying, on the first directory and the target document page, in response to the second type of operation on the first directory list, the second operation result of executing the second type of operation on the first directory list comprises:
uploading, in response to an upload operation on the second directory list, a target file, displaying an uploaded list entry corresponding to the target file in the second directory list, and displaying an uploaded directory entry corresponding to the uploaded list entry in the first directory.

13. The method according to claim 7, wherein displaying, on the first directory and the target document page, in response to the second type of operation on the first directory list, the second operation result of executing the second type of operation on the first directory list comprises:
modifying, in response to a transfer operation on a target list entry in the second directory list, an owner of a file corresponding to the target list entry.

14. The method according to claim 7, wherein the method further comprises, prior to responding to the second type of operation on the first directory list:
marking, in response to a single or multiple selection operation on the second directory list, one or more selected list entries in the second directory list.

15. The method according to claim 2, further comprising:
displaying, in response to a view switching operation on the second directory list, a view corresponding to the second directory list on the first document page.

16. The method according to claim 2, wherein the first-level directory comprises at least one of a document directory entry, a folder directory entry, and an image directory entry, and the second-level directory comprises at least one of a document directory entry, a folder directory entry, and an image directory entry.

17. The method according to claim 2, wherein the first document page comprises a plurality of unit blocks; and the method further comprises:
arranging a directory entry of the first-level directory on a first unit block, and arranging each directory entry of the second-level directory on a second unit block, wherein the second unit block is a sub-block of the first unit block.

18. The method according to claim 1, wherein the target document page and the first directory are displayed in a same window.

19. An electronic device, comprising a memory, a processor, and a computer program stored on the memory and executable on the processor, wherein the computer program, when executed by the processor, cause the processor to:
display a first directory, wherein the first directory comprises at least two levels of directories, and the directories are directories of a document space and are associated with one or more documents;
add, in response to an add operation on the first directory, a first directory list corresponding to the first directory in a target document page, wherein the first directory is associated with a target document; and
display, on the target document page, in response to a first type of operation on the first directory list, a first operation result after executing the first type of operation on the first directory list.

20. A non-transitory computer-readable storage medium, wherein the non-transitory computer-readable storage medium stores computer instructions, and the computer instructions are configured to cause a computer to:
display a first directory, wherein the first directory comprises at least two levels of directories, and the directories are directories of a document space and are associated with one or more documents;
add, in response to an add operation on the first directory, a first directory list corresponding to the first directory in a target document page, wherein the first directory is associated with a target document; and
display, on the target document page, in response to a first type of operation on the first directory list, a first operation result after executing the first type of operation on the first directory list.
